(19) United States
(12) Patent Application Publication
(10) Pub. No.: US 2016/0256853 A1
(43) Pub. Date: Sep. 8, 2016

(54) NITROGEN OXIDE REDUCTION CATALYST AND METHOD OF PREPARING THE SAME

(71) Applicants: SEOUL NATIONAL UNIVERSITY R&DB FOUNDATION, Seoul (KR); INDUSTRY FOUNDATION OF CHONNAM NATIONAL UNIVERSITY, Gwangju (KR)

(72) Inventors: Do Heui KIM, Seoul (KR); Seunghee YOUN, Seoul (KR); Inhak SONG, Seoul (KR); Sung June CHO, Gwangju (KR)

(21) Appl. No.: 15/050,455

(22) Filed: Feb. 22, 2016

(30) Foreign Application Priority Data
Mar. 3, 2015 (KR) 10-2015-0029934

(51) Int. Cl. B01J 21/06; B01J 37/04; B01J 37/02; B01J 23/22

(52) U.S. Cl. CPC B01J 21/063; B01J 23/22; B01J 37/04; B01J 37/0215

(57) ABSTRACT

Disclosed are a nitrogen oxide reduction catalyst and a method of preparing the same. The nitrogen oxide reduction catalyst includes a titanium oxide nanostructure as an active metal support, wherein the titanium oxide nanostructure has a polycrystalline structure formed through hydrothermal synthesis using a lithium hydroxide solution. The method of preparing the nitrogen oxide reduction catalyst includes mixing a lithium hydroxide solution with titanium oxide, wherein the titanium oxide is converted into a polycrystalline titanium oxide nanostructure by the lithium hydroxide solution.

### BACKGROUND OF THE INVENTION

1. Field of the Invention

The present invention relates to a nitrogen oxide reduction catalyst and a method of preparing the same.

2. Description of the Related Art

Nitrogen oxide (NOₓ), which is a compound of nitrogen and oxygen, is generated through the oxidation of nitrogen (N₂) present in the air during combustion at very high temperatures. Various kinds of nitrogen oxide are exemplary, and include nitrogen monoxide (NO) and nitrogen dioxide (NO₂), which mainly cause air pollution. Nitrogen oxide, which is present in the air, may cause a variety of diseases by stimulating the human eye and respiratory organs. Furthermore, nitrogen oxide causes acid rain, and may react with solar light to thus produce ozone, whereby photochemical smog may occur and environmental pollution may be caused. For this reason, countries including Europe have enacted policies for regulating nitrogen oxide in the air.

Nitrogen oxide is mainly generated from combustion facilities, such as power plants, industrial boilers, incinerators, etc., and the generation of nitrogen oxide is increasing in transport means such as cars and ships. Post-treatment systems usable in nitrogen oxide generation sources may include oxidation catalysts (DOC), diesel particulate filters (DPF), and selective catalytic reduction (SCR).

In particular, selective catalytic reduction (SCR) is a reaction for selectively reducing nitrogen oxide using an ammonia (NH₃) reductant in the presence of excess oxygen. The catalyst for SCR is mainly exemplified by a vanadium oxide catalyst loaded on titanium oxide (V₂O₅/TiO₂). The V₂O₅/TiO₂ catalyst suffers because of the low specific surface area of the titanium oxide support. Typically, the amount of vanadium oxide (V₂O₅) loaded on titanium oxide (TiO₂) is limited to the level that forms a monolayer. This is because the loading of vanadium oxide in an amount greater than the amount necessary to form the monolayer may cause the formation of crystalline vanadium oxide. The crystalline vanadium oxide does not efficiently reduce nitrogen oxide, but oxidizes ammonia (NH₃) or sulfur dioxide (SO₂) during the reaction, undesirably impeding the selective catalytic reduction. The conventional catalyst is problematic because an expensive co-catalyst has to be added in order to increase catalytic efficiency, making it difficult to achieve commercialization and economic benefits.

### SUMMARY OF THE INVENTION

Accordingly, the present invention has been made keeping in mind the above problems encountered in the related art, and the present invention is intended to provide a nitrogen oxide reduction catalyst on which a large amount of vanadium may be loaded.

Also, the present invention is intended to provide a nitrogen oxide reduction catalyst having high activity, even without the use of a co-catalyst.

Also, the present invention is intended to provide a method of preparing the nitrogen oxide reduction catalyst.

Exemplary embodiments of the present invention provide a nitrogen oxide reduction catalyst, comprising a titanium oxide nanostructure as an active metal support, wherein the titanium oxide nanostructure has a polycrystalline structure formed through hydrothermal synthesis using a lithium hydroxide (LiOH) solution.

The active metal may include at least one selected from among vanadium, tungsten, cerium, zinc, and manganese.

The active metal may be loaded in an amount of 1 to 10 parts by weight based on 100 parts by weight of the titanium oxide nano structure.

Exemplary embodiments of the present invention provide a method of preparing a nitrogen oxide reduction catalyst, comprising: mixing a lithium hydroxide (LiOH) solution with titanium oxide, wherein the titanium oxide is converted into a polycrystalline titanium oxide nanostructure by the lithium hydroxide solution.

The method may further include loading an active metal on the titanium oxide nanostructure.

The active metal may include at least one selected from among vanadium, tungsten, cerium, zinc, and manganese.

The active metal may be loaded in an amount of 1 to 10 parts by weight based on 100 parts by weight of the titanium oxide nano structure.

According to exemplary embodiments of the present invention, the nitrogen oxide reduction catalyst includes a titanium oxide nanostructure having a high specific surface area, thereby enabling the loading of vanadium in a large amount. The nitrogen oxide reduction catalyst can contain a large amount of vanadium loaded thereon, thereby exhibiting superior nitrogen oxide reduction efficiency across a wide temperature range. Furthermore, the nitrogen oxide reduction catalyst can show high nitrogen oxide reduction efficiency even without the use of a co-catalyst.

According to exemplary embodiments of the present invention, the method of preparing the nitrogen oxide reduction catalyst enables the economical and simple formation of the titanium oxide nanostructure, and is thus easy to commercialize.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a polycrystalline titanium oxide nanostructure according to an embodiment of the present invention;

FIG. 2 illustrates a nanotube-type titanium oxide nanostructure according to an embodiment of the present invention;

FIG. 3 illustrates a nanorod-type titanium oxide nanostructure according to an embodiment of the present invention;

FIG. 4 illustrates the results of SCR activity in the nitrogen oxide reduction catalysts according to embodiments of the present invention;

FIG. 5 illustrates the results of N₂O generation in the nitrogen oxide reduction catalysts according to embodiments of the present invention;

FIG. 6 illustrates the results of SCR activity depending on the amount of loaded vanadium in the nitrogen oxide reduction catalysts according to embodiments of the present invention;

FIG. 7 illustrates the results of N₂O generation depending on the amount of loaded vanadium in the nitrogen oxide reduction catalysts according to embodiments of the present invention;

FIG. 8 illustrates the results of SCR activity depending on the calcination temperature in the nitrogen oxide reduction catalysts according to embodiments of the present invention;

FIG. 9 illustrates the results of N₂O generation depending on the calcination temperature in the nitrogen oxide reduction catalysts according to embodiments of the present invention;

FIG. 10 illustrates the results of comparison of SCR activity of the nitrogen oxide reduction catalyst according to an embodiment of the present invention; and

FIG. 11 illustrates the results of comparison of N₂O generation of the nitrogen oxide reduction catalyst according to an embodiment of the present invention.

### DESCRIPTION OF SPECIFIC EMBODIMENTS

Hereinafter, a detailed description will be given of embodiments of the present invention. The objects, features, and advantages of the present invention may be easily understood through the following embodiments. The present invention is not limited to such embodiments, but may be embodied in other forms. The embodiments disclosed herein are merely provided to make the disclosed contents thorough and complete and to transfer the spirit of the present invention in a sufficient manner to those skilled in the art. Therefore, the present invention should not be limited by the following embodiments.

As used herein, the catalyst may be represented by the sequence in which metals are loaded on a support. For example, the case where metals A and B are sequentially loaded on S is represented by B/A/S.

As used herein, the metal loaded on a support may be represented by an element of the metal, or an oxide of the metal, which is merely set forth to show the loading of the metal on the support, and there is no difference therebetween. For example, a V₂O₅/TiO₂ catalyst may refer to vanadium loaded on TiO₂ or vanadium oxide loaded on TiO₂.

According to embodiments of the present invention, the nitrogen oxide reduction catalyst includes a titanium oxide nanostructure as an active metal support. The nitrogen oxide reduction catalyst including the titanium oxide nanostructure may exhibit high nitrogen oxide conversion across a wide temperature range, and low nitrous oxide (N₂O) generation compared to a catalyst including titanium oxide that is not a nanostructure.

The titanium oxide nanostructure may be formed through hydrothermal synthesis with an alkaline solution. Hydrothermal synthesis may include mixing titanium oxide with the alkaline solution and adjusting the temperature of the mixture in the temperature range of 70 to 250° C. The alkaline solution may include at least one selected from among lithium hydroxide (LiOH), sodium hydroxide (NaOH), and potassium hydroxide (KOH). The titanium oxide nanostructure may have at least one selected from among a polycrystalline structure, a nanotube structure, and a nanorod structure. The titanium oxide nanostructure may contain one or more pores having a diameter of 1 to 10 nm.

The structure of the titanium oxide nanostructure may vary depending on the kind of alkaline solution. For example, the titanium oxide nanostructure resulting from hydrothermal synthesis with the solution including lithium hydroxide may have a polycrystalline structure. The catalyst including a polycrystalline titanium oxide nanostructure showed excellent performance in the nitrogen oxide reduction reaction, and superior thermal stability after calcination at a high temperature (500° C.). In addition, the titanium oxide nanostructure resulting from hydrothermal synthesis with the solution including sodium hydroxide may have a nanotube structure. The titanium oxide nanostructure obtained through hydrothermal synthesis using the solution including potassium hydroxide may have a nanorod structure.

The active metal may include at least one selected from among vanadium, tungsten, cerium, zinc, and manganese. Preferably the active metal includes vanadium pentoxide (V₂O₅)

The active metal may be loaded in an amount of 1 to 10 parts by weight on the titanium oxide nanostructure. Preferably, the active metal is loaded in an amount of 1 to 5 parts by weight on the titanium oxide nanostructure. Given the above loading amount range, high nitrogen oxide conversion may result.

Further, at least one selected from among tungsten, cerium, zinc, and manganese may be loaded as a co-catalyst on the titanium oxide nanostructure. Preferably, at least one of tungsten and cerium is incorporated as a co-catalyst. For example, a W/Ce/V/Ti or Ce/W/V/Ti catalyst in which the tungsten, cerium and vanadium oxides are loaded on the titanium oxide nanostructure (Ti) may be formed.

The catalyst, which uses, as the support, a typical titanium oxide that is not a nanostructure, suffers due to the low specific surface area of the titanium oxide. Owing to the low specific surface area, the amount of vanadium oxide loaded on the titanium oxide is limited to the level that forms a monolayer. In the case where vanadium oxide is loaded in an amount greater than the amount necessary to form the monolayer, crystalline vanadium oxide may be produced. The crystalline vanadium oxide may not reduce nitrogen oxide, and may oxidize ammonia (NH₃) or sulfur dioxide (SO₂) during the reaction, thus impeding the reduction of nitrogen oxide. Furthermore, the catalyst using titanium oxide that is not a nanostructure is problematic because the N₂O generation is increased with an increase in the amount of loaded vanadium oxide. However, since nitrogen oxide conversion at low temperatures is in proportion to the amount of loaded vanadium oxide, the low-temperature activity may deteriorate when the vanadium oxide is loaded in a small amount.

The nitrogen oxide reduction catalyst includes the titanium oxide nanostructure having a high specific surface area as the support, whereby the crystalline vanadium oxide is not produced and a large amount of active metal may be loaded. Moreover, in the nitrogen oxide reduction catalyst, drawbacks of N₂O selectivity may be overcome through structural changes in the titanium oxide support, and the loading of the active metal, such as vanadium oxide, which directly affects the reaction, or auxiliary metal, need not be adjusted in a complicated manner depending on conditions such as temperature and the like.

According to embodiments of the present invention, the method of preparing the nitrogen oxide reduction catalyst includes mixing titanium oxide with an alkaline solution including at least one selected from among lithium hydroxide (LiOH), sodium hydroxide (NaOH), and potassium hydroxide (KOH), wherein the titanium oxide is converted into a titanium oxide nanostructure by the alkaline solution.

The titanium oxide may be exemplified by titanium dioxide (TiO₂ (Anatase)). The titanium oxide is mixed with the alkaline solution including at least one selected from among lithium hydroxide, sodium hydroxide, and potassium hydroxide. The alkaline solution may function as a peptizing agent that breaks the structure of titanium oxide. When hydrothermal synthesis is performed by adjusting the temperature of the titanium oxide and the alkaline solution, it is possible to synthesize the titanium oxide nanostructure having a high specific surface area. The above temperature is set to the range from 70 to 250° C., and preferably, from 120 to 170° C.

The hydrothermal synthesis method using the alkaline solution specifically may include at least one step selected from among preparing the alkaline solution, mixing the alkaline solution with the titanium oxide to form an alkaline mixture, adjusting the temperature of the alkaline mixture to 70 to 250° C., filtering the alkaline mixture with an acidic solution to form a filtrate, drying the filtrate, mixing the filtrate with an acidic solution and stirring and washing the mixture, washing the filtrate with distilled water to obtain a titanium oxide nanostructure, and drying the titanium oxide nanostructure.

For example, lithium hydroxide may be mixed with distilled water, thus forming a lithium hydroxide solution. The lithium hydroxide solution is added with titanium oxide and stirred for to 60 min, preferably 30 min, thus forming an alkaline mixture. The alkaline mixture may be placed in a rotary oven under conditions of 120 to 130° C. and 15 to 20 rpm for 25 to 35 hr. The alkaline mixture is cooled for 1 hr, and is then filtered with 0.1 N hydrochloric acid, whereby a filtrate may be formed. This procedure may be carried out until the pH is 1.5. The filtrate may be dried in an oven. The dried filtrate may be mixed with hydrochloric acid and washed for 6 hr. As such, the hydroxide may be removed from the filtrate. The filtrate may be washed with distilled water, thus obtaining the titanium oxide nanostructure. This procedure may be carried out until the pH is 7. The titanium oxide nanostructure may be dried in an oven.

The titanium oxide is decomposed by the alkaline solution, and is thus re-arranged in the mixed solution to form a novel structure. The titanium oxide nanostructure may have at least one selected from among a polycrystalline structure, a nanotube structure, and a nanorod structure. The titanium oxide nanostructure may contain one or more pores having a diameter of 1 to 10 nm.

The structure of the nanostructure formed through hydrothermal synthesis using the alkaline solution may vary depending on the kind of alkaline solution. For example, the titanium oxide nanostructure, which is hydrothermally synthesized using the solution including lithium hydroxide, may have a polycrystalline structure. The catalyst containing the polycrystalline titanium oxide nanostructure exhibited the highest performance in the nitrogen oxide reduction reaction, and superior thermal stability after calcination at a high temperature (500° C.). In addition, the titanium oxide nanostructure resulting from hydrothermal synthesis using the solution including sodium hydroxide may have a nanotube structure. The titanium oxide nanostructure resulting from hydrothermal synthesis using the solution including potassium hydroxide may have a nanorod structure.

The nitrogen oxide reduction catalyst may be prepared by loading the active metal on the titanium oxide nanostructure. The active metal may include at least one selected from among vanadium, tungsten, cerium, zinc, and manganese. The active metal preferably includes vanadium pentoxide (V₂O₅).

The amount of the active metal, which is loaded on the titanium oxide nanostructure, is 1 to 10 parts by weight, and preferably 1 to 5 parts by weight. Given the above loading amount range, the high nitrogen oxide conversion may result.

Further, at least one selected from among tungsten, cerium, zinc, and manganese may be loaded as a co-catalyst on the titanium oxide nanostructure. Preferably, at least one of tungsten and cerium is incorporated as a co-catalyst. For example, a W/Ce/V/Ti or Ce/W/V/Ti catalyst, in which tungsten, cerium and vanadium oxides are loaded on the titanium oxide nanostructure (Ti), may be formed.

The loading of the active metal on the titanium oxide nanostructure may include at least one step selected from among preparing the active metal precursor solution, adjusting the amount of loaded active metal, mixing the titanium oxide nanostructure with the active metal precursor solution, treating the mixed solution under pressure reduced below atmospheric pressure to evaporate the solvent to thus obtain a dry product, drying the dry product, and calcining the dry product.

For example, when the active metal is vanadium, the vanadium precursor solution may be prepared using purified water, ammonium metavanadate, and an oxalic acid solution. The amount of loaded vanadium precursor solution may be calculated such that the amount of vanadium is 1 to 5 parts by weight based on the amount of the titanium oxide nanostructure. The titanium oxide nanostructure may be mixed with the vanadium precursor solution. While the atmospheric pressure is lowered to a pressure of 100 to 300 mb, the solvent is evaporated from the mixed solution at 70 to 100° C., yielding the dry product. Preferably, the pressure is lowered from atmospheric pressure to 200 mb, and evaporation is performed at 80° C. The dry product is dried at 90 to 200° C., and preferably 100 to 110° C. Subsequently, the dry product is calcined at 300 to 600° C., and preferably 400 to 500° C., for 3 to 5 hr.

### Example

The catalyst formed in the present example is represented in a manner in which the amount of loaded vanadium (V) based on the mass of the titanium oxide nanostructure may be expressed as parts by weight in a position before the catalyst. For example, X parts by weight may refer to that V is contained in an amount of X g based on 100 g of titanium. The kind of alkali metal ion used to form the titanium oxide nanostructure may be shown in parentheses after TiO₂ .

In the present example, the SCR reaction was carried out under conditions of 500 ppm nitrogen monoxide (NO), 500 ppm ammonia (NH₃), 2% O₂, a balance of N₂, a space velocity (SV) of 40,000 h⁻¹, a heating rate of 5° C./min in a temperature range from 150° C. to 500° C., and a stabilization time of 30 min whenever the increase in the temperature was 50° C. in the above temperature range, after which the amounts of NO, NO₂, and N₂O were measured.

### Preparation of Titanium Oxide Nanostructure

7.185 g of lithium hydroxide (LiOH) was placed in a 125 ml plastic bottle (PP bottle), and reacted with 30 ml of distilled water, thus preparing a 10 M LiOH solution. Further, 1.6 g of titanium dioxide (TiO₂, anatase-99.8% Sigma Aldrich) was placed in the plastic bottle and stirred for 30 min, giving a mixed solution.

The mixed solution was placed in an autoclave, which was then placed in a rotary oven under the conditions of 400 K and 17 rpm for 30 hr. The mixed solution was cooled at room temperature for 1 hr, and then filtered with 0.1 N hydrochloric acid (HCl). The filtration process was performed until the pH was 1.5, after which the filtrate was dried in an oven.

The dried filtrate and 0.1 N HCl were placed in a 125 ml plastic bottle and stirred for 5 to 7 hr. The filtrate was repeatedly washed with distilled water until the pH was 7, and was then dried in an oven, thus forming the titanium oxide nano structure.

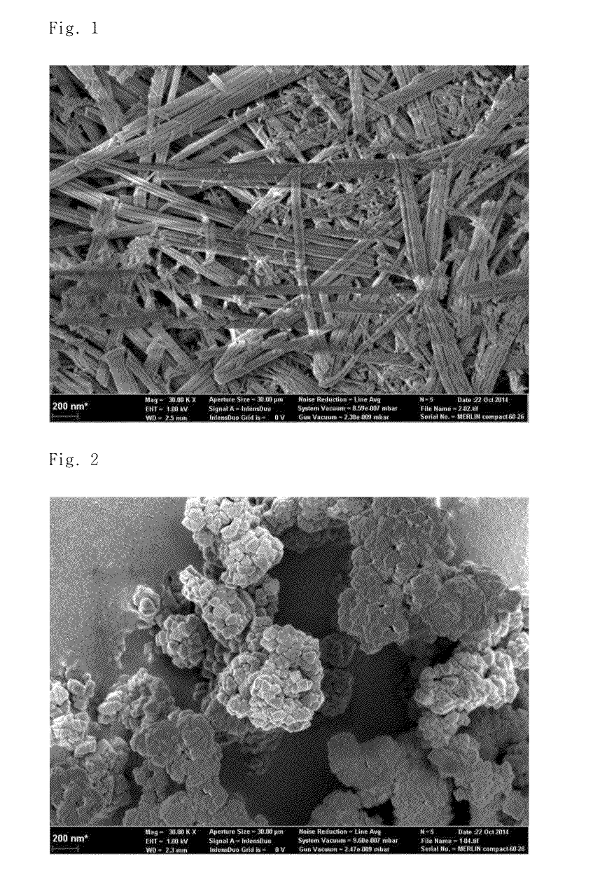

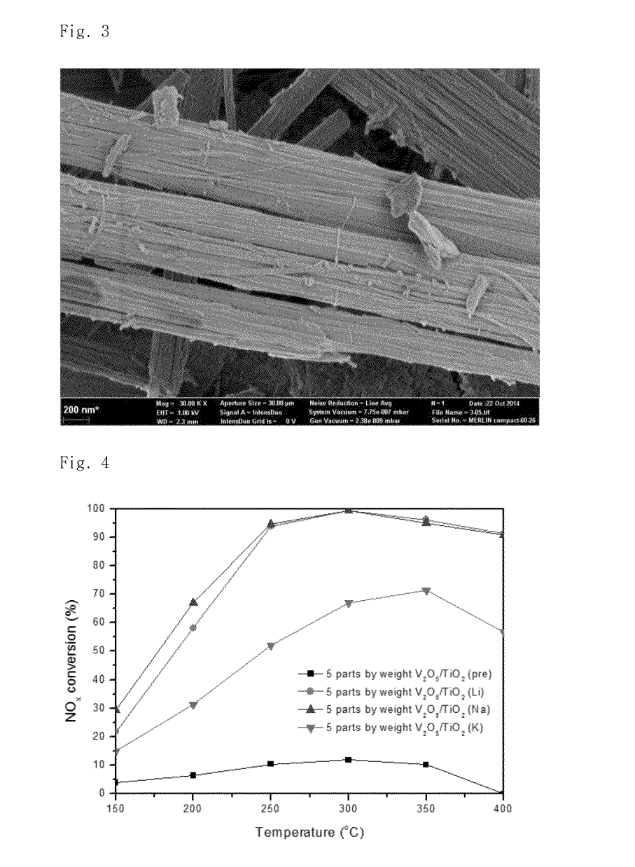

FIG. 1 illustrates the polycrystalline titanium oxide nanostructure according to an embodiment of the present invention, FIG. 2 illustrates the nanotube-type titanium oxide nanostructure according to an embodiment of the present invention, and FIG. 3 illustrates the nanorod-type titanium oxide nanostructure according to an embodiment of the present invention.

Illustrated in FIGS. 1 to 3 are the FE-SEM images of the titanium oxide nanostructures depending on the kind of alkaline solution. For lithium ions (Li⁺), the polycrystalline structure having fine pores may be formed. For sodium ions (Na⁺), the nanotube structure may be formed. For potassium ions (K⁺), the nanorod structure may be formed. FIGS. 1 to 3 illustrate the nitrogen oxide reduction catalysts after calcination at 400° C., in which the structural properties obtained after treatment with the alkaline solution were maintained without change even after calcination (thermal treatment).

TABLE 1

| | | | | Titanium |
|---|---|---|---|---|
| | | Titanium | Titanium | oxide |
| | | oxide | oxide | nano- |
| | Titanium | nanostructure | nanostructure | structure |
| | oxide | (Li) | (Na) | (K) |
| S_{BET} (m²/g) | 10 | 241 | 214 | 170 |
| Pore volume | 0.02 | 0.20 | 0.60 | 0.46 |
| (cm³/g) | | | | |

Table 1 shows the surface area and the pore volume of the titanium oxide nanostructure analyzed through N₂ adsorption- desorption testing. As is apparent from Table 1, the BET specific surface area was increased at least 10 times compared to that of conventional titanium oxide, the increase in the surface area being greatest in the sequence of Li>Na>K. The average volume of pores was increased at least 10 times compared to that of conventional titanium oxide, and the increase in the pore volume was greatest in the sequence of Na>K>Li.

### Preparation of V₂O₅/TiO₂ Catalyst Using Titanium Oxide Nanostructure

1.345 g of ammonium metavanadate was added to and dissolved in 100 ml of tertiary purified water and 70 ml of a 0.5 M oxalic acid solution, thus preparing a vanadium precursor solution. The amount of the vanadium precursor solution was calculated such that the amount of vanadium element was 1 wt %, 3 wt %, and 5 wt % based on the amount of titanium oxide. 1 g of the titanium oxide nanostructure was placed in a round-bottom flask, after which the vanadium precursor solution was added in an amount appropriate for the calculated loading amount. While the pressure was gradually lowered from atmospheric pressure to 200 mb, the solution was evaporated at 80° C., thus forming a catalyst. Thereafter, the catalyst was dried in an oven at 105° C. for 10 to 14 hr. The catalyst was calcined at a calcination temperature (400° C. or 500° C.) for 3 to 5 hr.

FIG. 4 illustrates the results of SCR activity in the nitrogen oxide reduction catalysts according to embodiments of the present invention, and FIG. 5 illustrates the results of N₂O generation in the nitrogen oxide reduction catalysts according to embodiments of the present invention. Specifically, the vanadium oxide, as the active metal, was loaded in an amount of 5 parts by weight on the titanium oxide nanostructure and then calcined at 400° C., and the SCR activity was evaluated. For comparison, vanadium was loaded in the same amount on titanium oxide (TiO₂ (Anatase)) before treatment with the alkaline solution (5 parts by weight, V₂O₅/TiO₂ (pre)) and the same test was performed.

As illustrated in FIGS. 4 and 5, the catalysts treated with lithium and sodium exhibited superior activity in the temperature range of 150 to 400° C. Further, the N₂O generation at 400° C. was decreased to less than 20 ppm for the catalysts treated with lithium and sodium. This is because the vanadium active metal is efficiently dispersed due to the large specific surface area of the titanium oxide nanostructure. Taking into consideration the low-temperature activity and the N₂O generation, the titanium oxide nanostructure treated with the lithium hydroxide aqueous solution was regarded as being very suitable for use as the vanadium support.

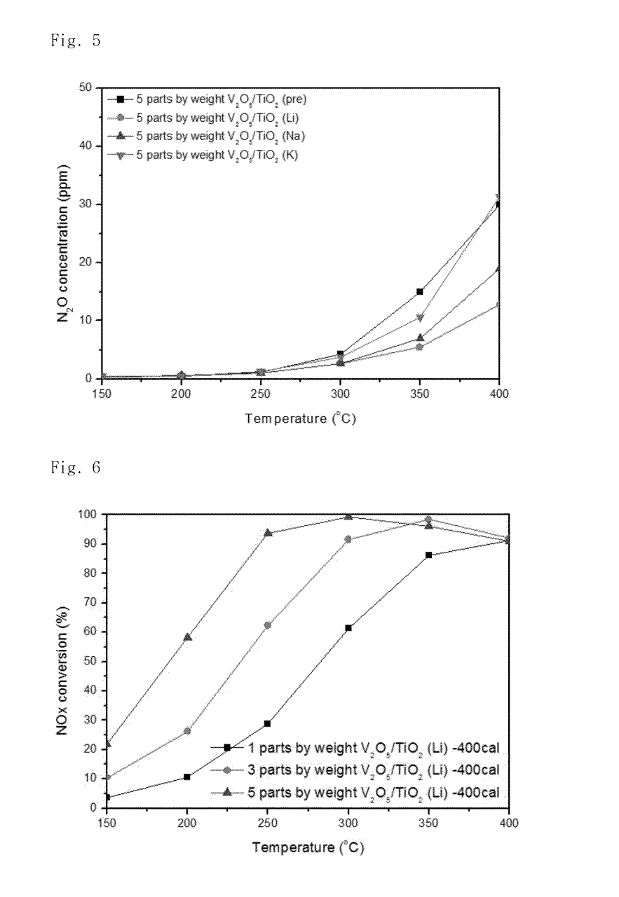

FIG. 6 illustrates the results of SCR activity depending on the amount of loaded vanadium in the nitrogen oxide reduction catalysts according to embodiments of the present invention, and

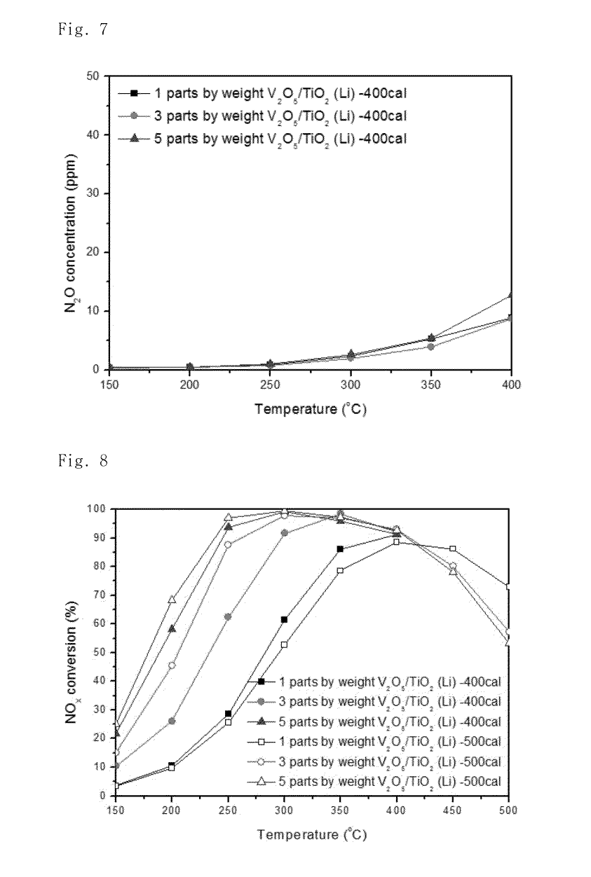

FIG. 7 illustrates the results of N₂O generation depending on the amount of loaded vanadium in the nitrogen oxide reduction catalysts according to embodiments of the present invention. As illustrated in FIGS. 6 and 7, when the SCR reaction was carried out under the condition that the amount of loaded vanadium was adjusted to 1, 3 and 5 parts by weight based on 100 parts by weight of the titanium oxide nanostructure, the relationship between the low-temperature activity and the N₂O generation could be confirmed. As the amount of loaded vanadium was increased, the nitrogen oxide conversion was increased across the entire temperature range. From the aspect of N₂O generation, as the amount of vanadium loaded on typical titanium oxide was increased, the N₂O generation was increased. However, for the polycrystalline titanium oxide nanostructure (Li), even when the amount of loaded vanadium was increased, the N₂O generation was not significantly changed. Accordingly, the polycrystalline titanium oxide nanostructure manifested superior catalytic efficiency.

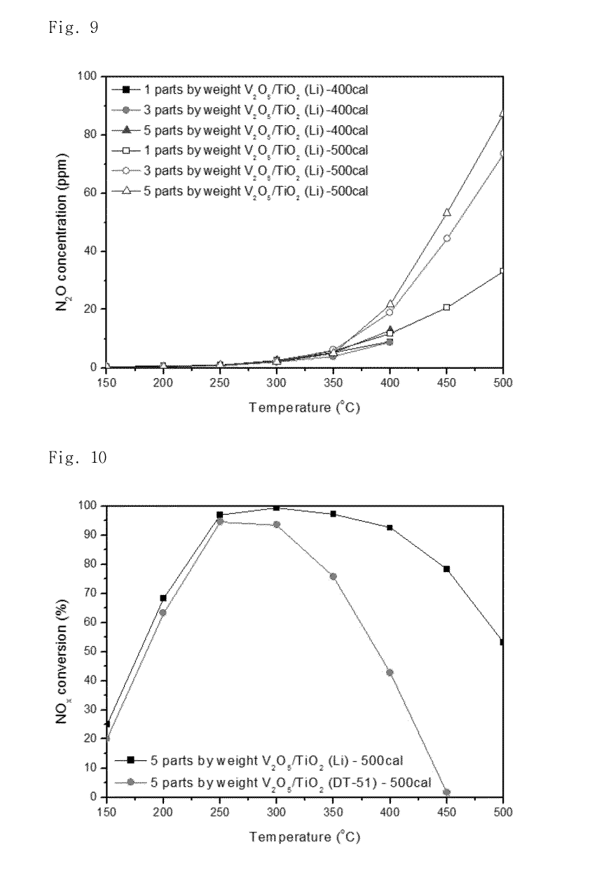

FIG. 8 illustrates the results of SCR activity depending on the calcination temperature in the nitrogen oxide reduction catalysts according to embodiments of the present invention, and FIG. 9 illustrates the results of N₂O generation depending on the calcination temperature in the nitrogen oxide reduction catalysts according to embodiments of the present invention. Since the calcination temperature may change the structural properties of the titanium oxide support (TiO₂), it is considered to be an important factor in terms of catalyst durability. Also, the calcination temperature is important because it is associated with the sintering of the active metal. Therefore, the catalyst was calcined at a high temperature of 500° C., after which the SCR reaction was carried out.

As illustrated in FIGS. 8 and 9, the catalyst configured such that 1 part by weight of vanadium was loaded based on 100 parts by weight of the titanium oxide nanostructure was decreased in activity throughout the entire temperature range after calcination at 500° C. In contrast, when the catalysts configured such that vanadium was loaded in amounts of 3 parts by weight and 5 parts by weight were calcined at 500° C., the activity thereof was increased in a low temperature range of 150 to 250° C. Also, the N₂O generation was not significantly increased at a calcination temperature of 500° C. Therefore, the catalyst configured such that vanadium was loaded in an amount of 3 to 5 parts by weight based on 100 parts by weight of the titanium oxide nanostructure was preferable in the SCR reaction.

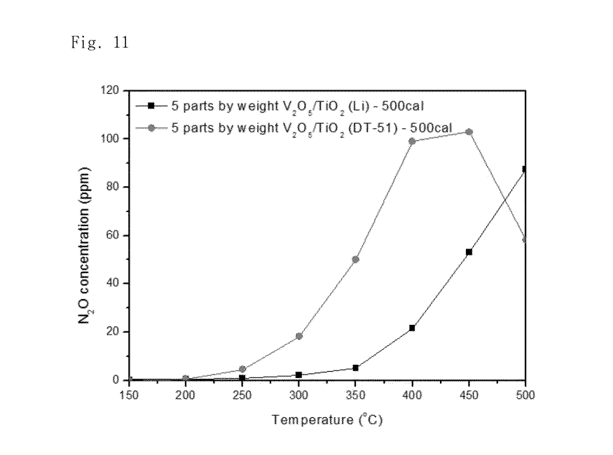

FIG. 10 illustrates the results of comparison of SCR activity of the nitrogen oxide reduction catalyst according to an embodiment of the present invention, and FIG. 11 illustrates the results of comparison of N₂O generation of the nitrogen oxide reduction catalyst according to an embodiment of the present invention.

As illustrated in FIGS. 10 and 11, when typical titanium oxide (TiO₂ (DT-51)) and the titanium oxide nanostructure (TiO₂ (Li)) were used as the support, there was a difference in nitrogen oxide reduction performance. Specifically, vanadium was loaded in an amount of 5 parts by weight on each of TiO₂ (DT-51) and TiO₂ (Li) and then calcined at 500° C., after which the SCR reaction was carried out. The TiO₂ (DT-51) was decreased in NOₓ conversion due to the high-temperature sintering and was increased in N₂O generation. Compared to the TiO₂ (DT-51), however, the TiO₂ (Li) exhibited high NOₓ conversion across a wide temperature range, and thus the titanium oxide nanostructure manifested superior SCR activity. Furthermore, the TiO₂ (Li) showed low N₂O generation even at high temperatures, whereby the titanium oxide nanostructure exhibited superior performance compared to typical titanium oxide. Therefore, the catalyst using the titanium oxide nanostructure as the support showed superior SCR activity even without the use of a co-catalyst such as tungsten.

Although the preferred embodiments of the present invention have been disclosed for illustrative purposes, those skilled in the art will appreciate that various modifications and other equivalent embodiments are possible from the embodiments, without departing from the scope and spirit of the invention as disclosed in the accompanying claims. The disclosed embodiments should be considered to be exemplary rather than restrictive. The scope of the present invention is shown not in the above description but in the claims, and all differences within the range equivalent thereto will be understood to be incorporated in the present invention.

What is claimed is:

1. A nitrogen oxide reduction catalyst, comprising a titanium oxide nanostructure as an active metal support, wherein the titanium oxide nanostructure has a polycrystalline structure formed through hydrothermal synthesis using a lithium hydroxide (LiOH) solution.

2. The nitrogen oxide reduction catalyst of claim 1, wherein the active metal comprises at least one selected from among vanadium, tungsten, cerium, zinc, and manganese.

3. The nitrogen oxide reduction catalyst of claim 1, wherein the active metal is loaded in an amount of 1 to 10 parts by weight based on 100 parts by weight of the titanium oxide nano structure.

4. A method of preparing a nitrogen oxide reduction catalyst, comprising:
mixing a lithium hydroxide (LiOH) solution with titanium oxide,
wherein the titanium oxide is converted into a polycrystalline titanium oxide nanostructure by the lithium hydroxide solution.

5. The method of claim 4, further comprising loading an active metal on the titanium oxide nanostructure.

6. The method of claim 5, wherein the active metal comprises at least one selected from among vanadium, tungsten, cerium, zinc, and manganese.

7. The method of claim 5, wherein the active metal is loaded in an amount of 1 to 10 parts by weight based on 100 parts by weight of the titanium oxide nanostructure.
